(19) United States
(12) Patent Application Publication
(10) Pub. No.: US 2012/0094059 A1
(43) Pub. Date: Apr. 19, 2012

(54) NYLON CARPET FIBERS HAVING BLEACH RESISTANCE

(75) Inventors: Kevin Leonard Urman, Lugoff, SC (US); Sundar Mohan Rao, Chattanooga, TN (US); Isaac Keene Ivedrson, Colombia, SC (US)

(73) Assignee: INVISTA NORTH AMERICA S.a r.l., Wilmington, DE (US)

(21) Appl. No.: 13/319,214

(22) PCT Filed: May 11, 2010
(86) PCT No.: PCT/US10/34388

§ 371 Date: Jan. 5, 2012

Related U.S. Application Data
(60) Provisional application No. 61/176,999, filed on May 11, 2009.

(51) Int. Cl. B32B 3/02; C08L 77/02; D05C 15/04; D01F 8/00; D01F 2/16; C08L 77/06; D06M 101/34

(52) U.S. Cl. 428/97; 525/432; 524/538; 8/494; 264/172.13; 264/78; 156/72

(57) ABSTRACT

The present invention relates to a nylon yarn of a finely dispersed melt blended polymer alloy having i) a polyamide component selected from polyhexamethyleneadipamide, polycaprolactam and mixtures thereof, and ii) a nylon 11 component; wherein the polyamide component is the major component by weight of the total melt blended polymer and wherein the polyamide component has a viscosity of about 2.6 IV or more as measured in 96% sulfuric acid. The resulting nylon yarn shows improved bleach resistance. The present invention also relates to processes of producing the yarn and nylon carpets comprising the yarn described above.

### FIELD OF THE INVENTION

The present invention pertains to bleach resistant carpet yarns formed from high viscosity polyhexamethyleneadipamide, high viscosity polycaprolactam, and mixtures thereof which are alloyed in melt form with minor amounts of moderately long chain polyamides. The present invention also pertains to such yarns that have been pigmented or dyed or both pigmented and dyed, and which are resistant to the bleaching of said dyes and pigments.

### BACKGROUND OF THE INVENTION

Polyamide fibers, including nylon, are considered the premium materials for the manufacture of tufted goods, including rugs and carpets. Among their chief advantages is their suitability to be made into durable, uniform goods which can be dyed in a wide range of colors and which can retain their original appearance for years, and even decades, depending on the environmental conditions of use. A singular advantage of melt spun synthetics, including the polyamides generally referred to as nylons, compared to natural fibers, for example wool, is that they can be colored by pigments through the entire fiber cross-section. In contrast, dyes are applied topically and they may not penetrate the entire fiber.

Whether dyed or pigmented, polyamides generally contain amine functionality that is dyeable, and a number of advancements have been made to limit the availability of such amine groups after carpets are dyed in order to prevent further dyeing and staining. Until the present invention however, carpets made of nylon yarns that have been colored with organic dyes and pigments have been easily stained by exposure to harsh cleaning agents containing strong oxidizing agents such as chlorine bleach. This is readily understood, as organic dyes and pigments are generally intolerant of strong oxidizing agents. Dyes tend to be even more susceptible to oxidation than pigments, because as mentioned above, they are applied topically, so they tend to be somewhat more exposed to oxidation.

As mentioned previously, a key aspect of polyamide carpet yarns is their ability to be dyed and pigmented in a variety of colors, both deeply and uniformly, to create the many styles of nylon carpets sold today. Nevertheless, many of the dyes and pigments that are used on nylon carpets are intolerant of oxidizing agents like chlorine bleach; even brief exposure to dilute bleach solutions can create permanent light color stains.

### SUMMARY OF THE INVENTION

The ability to withstand such treatment without degradation is generally desirable, and especially desirable in public locations like schools, hospitals and the like, where strong cleaners and disinfectants are often employed. Furthermore, while bleach resistance is highly desirable in such applications, such resistance is of little value if the wear performance of the carpet is compromised in any significant way.

Because appearance retention is an essential aspect of nylon yarn and the higher value it provides to finished carpet, improved nylon yarns that exhibit excellent wear performance while also having bleach tolerance is highly desirable.

In accordance with the present invention, it has been discovered that polyamide yarns can be provided with varying degrees of resistance to oxidizing agents, such as bleach, without significant compromise of other yarn properties by combination in melt phase of a major component of a high viscosity polyhexamethyleneadipamide, polycaprolactam, or mixtures thereof with a minor component of a moderately long chain polyamide to form a finely dispersed alloy in a high viscosity polyhexamethyleneadipamide and/or polycaprolactam polymer matrix. Improved bleach resistance is exhibited by the yarn of the present invention and also by the same yarn after it is dyed with bleach susceptible dyes.

In one aspect, a nylon yarn is disclosed comprising a finely dispersed melt blended polymer alloy comprising i) a polyamide component selected from the group consisting of polyhexamethyleneadipamide, polycaprolactam and mixtures thereof, and ii) a nylon 11 component; wherein the polyamide component has a viscosity of about 2.6 IV or more as measured in 96% sulfuric acid, and is the major component by weight of the total melt blended polymer. The polyamide component can be present from about 98% to about 65% by weight of the total melt blended polymer, and the nylon 11 component is dispersed in separately detectable regions that are enclosed by, but not dissolved in, the polyamide component.

In another aspect, a process for producing nylon yarn is disclosed, comprising: melt blending in an extrusion process consisting of either a twin screw or a single screw extruder with a mixing head, a polyamide component selected from the group consisting of polycaprolactam, polyhexamethylenediapamide and mixtures thereof, with a nylon 11 component to form a finely dispersed melt blended polymer alloy; extruding the melt blended polymer alloy through a spinneret to form filaments; and converging the filaments into a yarn and winding the yarn, wherein the polyamide component comprises at least about 65% by weight of the melt blended polymer alloy, and further wherein the polyamide component has a viscosity of about 2.6 IV or more as measured in 96% sulfuric acid, wherein the nylon 11 component remains in separately detectable regions of the yarn, enclosed by, but not dissolved in, the polyamide component.

In a further aspect, a process for producing a bleach resistant nylon carpet is disclosed, comprising: melt mixing a polyamide component selected from the group consisting of polycaprolactam, polyhexamethyleneadipamide, and mixtures thereof, with a nylon 11 component to form a finely dispersed melt blended polymer alloy; extruding the melt blended polymer alloy through a spinneret to form filaments; converging the filaments into a yarn; drawing the yarn; bulk texturing the yarn; winding the yarn; tufting the yarn into a carpet; and optionally dyeing the carpet, wherein the polyamide component has a viscosity of about 2.6 IV or more as measured in 96% sulfuric acid, and wherein the nylon 11 component of the yarn is dispersed in separately detectable regions which are enclosed by, but not dissolved in, the polyamide component.

In yet another aspect, a process for producing a pigmented, bleach resistant nylon carpet is disclosed, comprising: melt mixing a polyamide component selected from the group consisting of polycaprolactam, polyhexamethyleneadipamide, and mixtures thereof, with a nylon 11 component and a minor pigmented polymer component, to form a finely dispersed pigmented, melt blended polymer alloy; extruding the melt blended polymer alloy through a spinneret to form filaments; converging the filaments into a yarn; drawing the yarn; bulk texturing the yarn; winding the yarn; tufting the yarn into a carpet; and optionally dyeing the carpet, wherein the polyamide component has a viscosity of about 2.6 IV or more as measured in 96% sulfuric acid, and wherein the nylon 11 component of the yarn is dispersed in separately detectable regions which are enclosed by, but not dissolved in, the polyamide component.

In yet a further aspect, a bleach resistant nylon carpet is disclosed comprising: (i) a polyamide yarn comprising a finely dispersed melt blended polymer alloy comprising a polyamide component selected from the group consisting of polycaprolactam, polyhexamethyleneadipamide, and mixtures thereof, and a nylon 11 component; and (ii) carpet backing, wherein the polyamide component has a viscosity of about 2.6 IV or more as measured in 96% sulfuric acid, and the nylon 11 component of the yarn is dispersed in separately detectable regions which are enclosed by, but not dissolved in, the polyamide component.

The polyamide yarns can be pigmented, dyed, or both. Further, the nylon carpets can be dyed, comprise pigmented nylon, or be dyed and comprise pigmented nylon. The above polyamide yarns and nylon carpets show improved bleach resistance over polyamide yarns and nylon carpets without a nylon 11 component.

### BRIEF DESCRIPTION OF THE FIGURES

FIGS. 1a and 1b show the morphology of a nylon 6,6+nylon 11 (10% by weight) polymer alloy and nylon 6+nylon 11 (10% by weight) polymer alloy.

FIG. 2 shows the melting point DSC curves of nylon 6 plus 10% nylon 6,10; 16% nylon 6,10; and 10% nylon 11 knitted socks, respectively, before bleaching.

FIG. 3 shows the melting point DSC curves of nylon 6 plus 10% nylon 6,10; 16% nylon 6,10; and 10% nylon 11 knitted socks, respectively, after 4 hours of bleaching.

FIG. 4 shows the melting point DSC curves of nylon 6 plus 10% nylon 6,10; 16% nylon 6,10; and 10% nylon 11 knitted socks, respectively, after 24 hours of bleaching.

FIGS. 5a and 5b show the melting point DSC curves of nylon 6, plus 10% nylon 6,10 and 10% nylon 11, respectively.

FIG. 6 shows the melting point DSC curve of nylon 6,6.

FIG. 7 shows the melting point DSC curve of nylon 6,6 plus 10% nylon 11.

### DETAILED DESCRIPTION OF THE INVENTION

A nylon yarn is disclosed comprising a finely dispersed melt blended polymer alloy comprising i) a polyamide component selected from the group consisting of polyhexamethyleneadipamide, polycaprolactam and mixtures thereof, and ii) a nylon 11 component, wherein the polyamide component has a viscosity of about 2.6 IV or more as measured in 96% sulfuric acid, and is the major component by weight of the total melt blended polymer. The nylon 11 minor component of the yarn is dispersed in separately detectable regions which are enclosed by but not dissolved in the polyamide component, and can be present at a concentration in the range of about 2 percent by weight to about 35 percent by weight of the total melt blended polymer, for example in the range of about 5 percent by weight to about 20 percent by weight of the total melt blended polymer or in the range of about 10 percent by weight to about 20 percent by weight of the total melt blended polymer, including about 10% by weight. The viscosity of the polyamide component can be in the range of from about 2.6 IV to about 4 IV as measured in 96% sulfuric acid, for example about 2.7 IV to about 3.5 IV or about 3.0 IV to about 3.4 IV as measured in 96% sulfuric acid. The viscosity of the polyamide component can also be measured as RV and can be about 55 RV or more as measured in formic acid, for example in the range of from about 55 RV to about 90 RV as measured in formic acid, for example about 60 RV to about 80 RV or about 60 RV to about 75 RV as measured in formic acid. The nylon yarn can further comprise a dye, for example an acid dye or a disperse dye, a pigment, for example an organic pigment, or both.

Also disclosed is a process for producing nylon yarn comprising: melt blending in an extrusion process a polyamide component selected from the group consisting of polycaprolactam, polyhexamethylenediapamide and mixtures thereof, with a nylon 11 component to form a finely dispersed melt blended polymer alloy; extruding the melt blended polymer alloy through a spinneret to form filaments; and converging the filaments into a yarn and winding the yarn, wherein the polyamide component comprises at least about 65% by weight of the melt blended polymer alloy, and further wherein the f polyamide component has a viscosity of about 2.6 IV or more as measured in 96% sulfuric acid. The melt blended polymer alloy can further comprise a pigment, for example an organic pigment, which may be contained in the polyamide component, the nylon 11 component, or in an additional polymeric minor component supplied in the form of pigmented pellets prior to melting, such as those used to create pigmented nylon yarns [see for example U.S. Pat. No. 5,830,572 to Anton et al]. The pigment can also be a nylon 6 pigmented polymer. The process can further comprise steps of drawing and bulk-texturing the yarn. The process can further comprise the step of dyeing the yarn, for example wherein the dye is an acid dye or a disperse dye.

The extrusion process can be performed using a single or twin screw extruder with a mixing head that imparts moderately high sheer mixing. The moderately high sheer mixing allows for the fine dispersion of the nylon 11 component in the polyamide component.

The nylon 11 can be present at a concentration in the range of about 2 percent by weight to about 35 percent by weight of the total melt blended polymer, for example in the range of about 5 percent by weight to about 20 percent by weight of the total melt blended polymer or in the range of about 10 percent by weight to about 20 percent by weight of the total melt blended polymer, including about 10 percent by weight. The viscosity of the polyamide component can be in the range of from about 2.6 IV to about 4 IV as measured in 96% sulfuric acid, for example about 2.7 IV to about 3.5 IV or about 3.0 IV to about 3.4 IV as measured in 96% sulfuric acid. The viscosity of the polyamide component can also be measured as RV and can be about 55 RV or more as measured in formic acid, for example in the range of from about 55 RV to about 90 RV as measured in formic acid, for example about 60 RV to about 80 RV or about 60 RV to about 75 RV as measured in formic acid.

In the process of the invention, at least two polymers, a major polyamide component (first) and a minor (second) nylon 11 polymer component are fed into an extruder, melted, and mixed in melt form to form a polymer alloy. Pre-compounding of the major and minor polymer components and side-stream addition of either one or both polymer components are suitable alternatives to co-feeding in solid form provided that the total time the components spend together in melt form is suitably short, less than about 30 minutes, including less than about 20 minutes, and also provided that the polymer viscosity of the major component is higher than that of the minor component at melt temperature, and that the extrusion process is performed with sufficient shearing to provide for fine dispersion of the minor component within the major component.

In one example a (Berstorff Type ZE40) 40 mm twin screw extruder with a bilobal geometry including multiple mixing elements was used to melt mix the polymer mixture with sufficient shear to create the polymer alloy of nylon 6,6 and nylon 11. The extruder screw speed was set at 190 rpm and the temperature profile was set up at 230° C. at the feed and 285° C. at the discharge. Nylon 6,6 polymer with a relative viscosity of 60 (RV) the major polyamide component, and nylon 11 pellets (BESNO grade polyamide 11, available from Arkema) the minor component, were co-fed into the extruder throat. The molten polymer alloy was formed in the extruder and pumped by the extruder pumping section through a booster pump into a transfer line. The melted polymer mixture was conveyed through the transfer line to a spinning pump and then to a filter pack and spinneret under sufficient pressure to form polymer filaments. The polymer filaments were quenched in air, coated with a lubricating finish, drawn, bulked, interlaced and wound onto a paper tube.

Yarn processing, optionally including twisting and heat-setting, can then be followed by tufting, dyeing and finishing.

Mixing efficiency, time in melt and melt temperature are each controlled in order to provide an effectively blended mix of the moderately long chain polyamides into the majority nylon polymer component to form a polymer alloy, without forming a random co-polymer of the two polyamide components. This is important to carpet yarns because random co-polymers tend to have lower overall polymer orientation and crystallinity, attributes which are directly related to key desirable physical properties like bulk recovery, i.e. the ability of a carpet to “spring back” after crushing. Appearance retention results for compositions having in the range of about 10-20% of the minor component for yarn to be used in carpets with high crush recovery are shown below.

The size and type of the extruder substantially affects the indicated process variables, as do the hold-up time between extruder and spinneret and the nature of mixing elements on either the extruder screw or in the pathway conveying to the spinneret. Inadequate mixing leads to poor dispersion and non-uniform yarn qualities, and can also lead to poor spinning and processing owing to weaknesses caused by inconsistency along the length of the yarn fibers. Alternatively, excessive heat and time in the melt phase can lead to transamidation, and loss of physical properties. Therefore, un-swept or “dead” volume, including oversized polymer transfer line pipes, should be avoided in the melt phase.

Further disclosed is a process for producing a bleach resistant nylon carpet comprising: melt mixing a polyamide component selected from the group consisting of polycaprolactam, polyhexamethyleneadipamide, and mixtures thereof, with a nylon 11 component to form a melt blended polymer alloy; extruding the melt blended polymer alloy through a spinneret to form filaments; converging the filaments into a yarn; drawing the yarn; bulk texturing the yarn; winding the yarn; tufting the yarn into a carpet; and optionally dyeing the carpet, wherein the polyamide component has a viscosity of about 2.6 IV or more as measured in 96% sulfuric acid and the nylon 11 component of the yarn is dispersed in separately detectable regions which are enclosed by but not dissolved in the polyamide component. The melt blended polymer alloy can further comprise a pigment, for example an organic pigment, as a minor polymeric component in the melt blended polymer alloy. The carpet can be dyed with dye, for example an acid dye or a dispersed dye. The process can further comprise the step of treating the carpet with a stain resistant chemical and/or a soil resistant chemical.

In yet another aspect, a bleach resistant nylon carpet is disclosed comprising: (i) a polyamide yarn comprising a melt blended polymer alloy comprising a polyamide component selected from the group consisting of polycaprolactam, polyhexamethyleneadipamide, and mixtures thereof, and a nylon 11 component; and (ii) carpet backing, wherein the polyamide component has a viscosity of about 2.6 IV or more as measured in 96% sulfuric acid and the nylon 11 component of the yarn is dispersed in separately detectable regions which are enclosed by but not dissolved in the polyamide component. The carpet can also be dyed, including with an acid or disperse dye, pigmented, including with an organic pigment contained in the polymer matrix of the yarn, or a combination of both.

The nylon 11 in the disclosed carpet and method of making the same can be present at a concentration in the range of about 2 percent by weight to about 35 percent by weight of the total melt blended polymer alloy, for example in the range of about 5 percent by weight to about 20 percent by weight of the total melt blended polymer or in the range of about 10 percent by weight to about 20 percent by weight of the total melt blended polymer, including about 10 percent by weight. Furthermore, the viscosity of the polyamide component can be in the range of from about 2.6 IV to about 4 IV as measured in 96% sulfuric acid, for example about 2.7 IV to about 3.5 IV or about 3.0 IV to about 3.4 IV as measured in 96% sulfuric acid. The viscosity of the polyamide component can also be measured as RV and can be about 55 RV or more as measured in formic acid, for example in the range of from about 55 RV to about 90 RV as measured in formic acid, for example about 60 RV to about 80 RV or about 60 RV to about 75 RV as measured in formic acid.

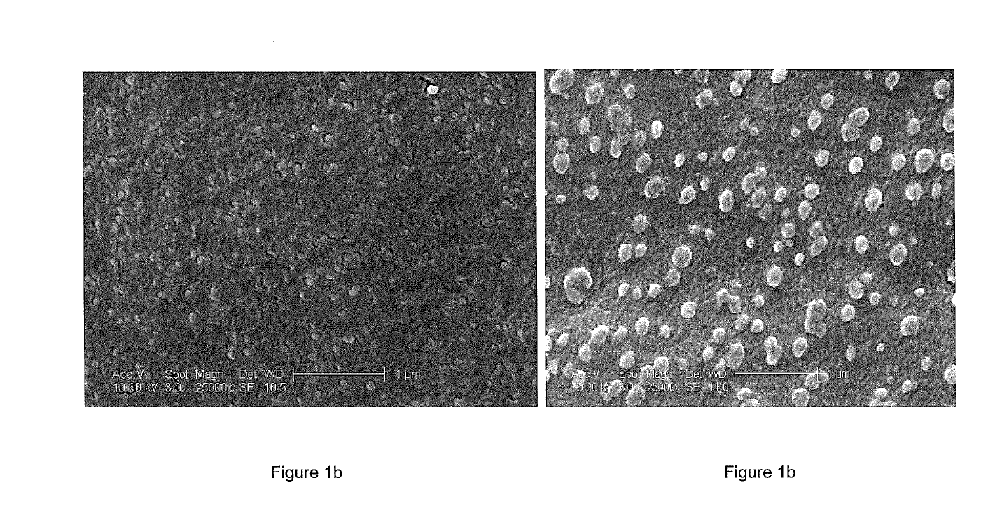

As shown in FIG. 1, the two polymer components form a polymer alloy, where the minor polymer component (nylon 11) is finely dispersed in a matrix of the major polymer (polyamide component). This forms an “island in the sea” composition having micro-disperse consistency, where the components are substantially immiscible. Specifically, the average minor polymer component size ranges from about 0.150 microns to about 0.70 microns, including about 0.110 microns to about 0.75 microns, in a matrix of the major component. Particle size is inversely proportional to extruder rpm. This polymer alloy is different than a soluble or fully miscible melt blend or a “molecular dispersion” associated with co-polymerizing two polymer components. Further, the polymer alloy is not a block or random co-polymer.

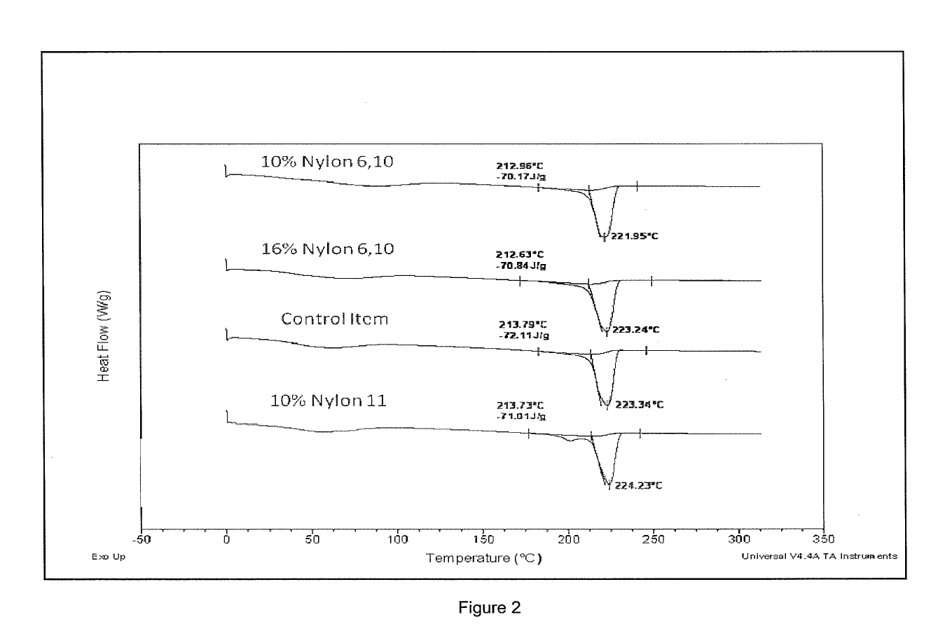

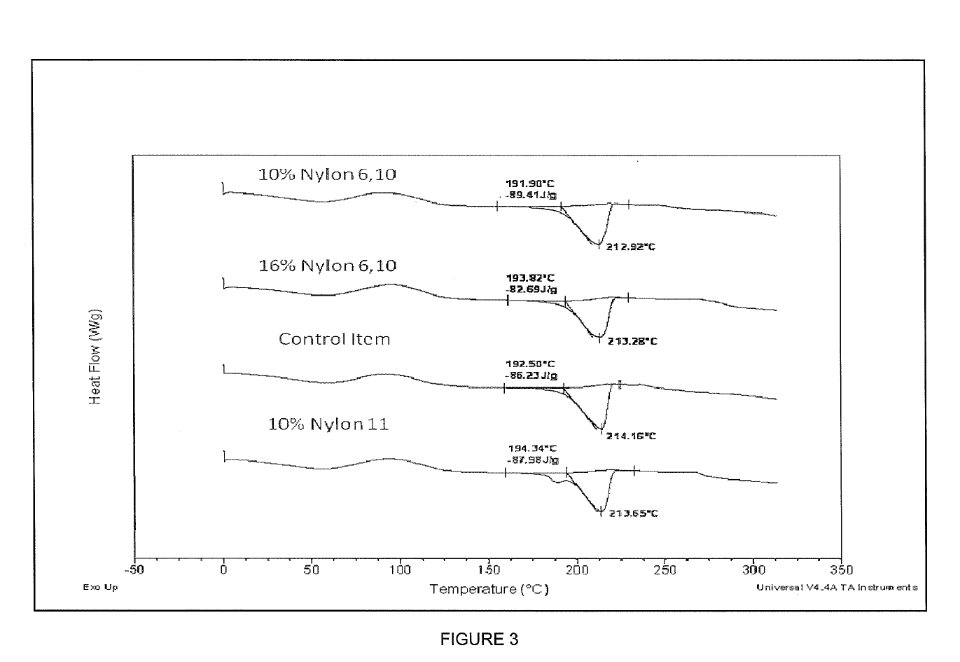

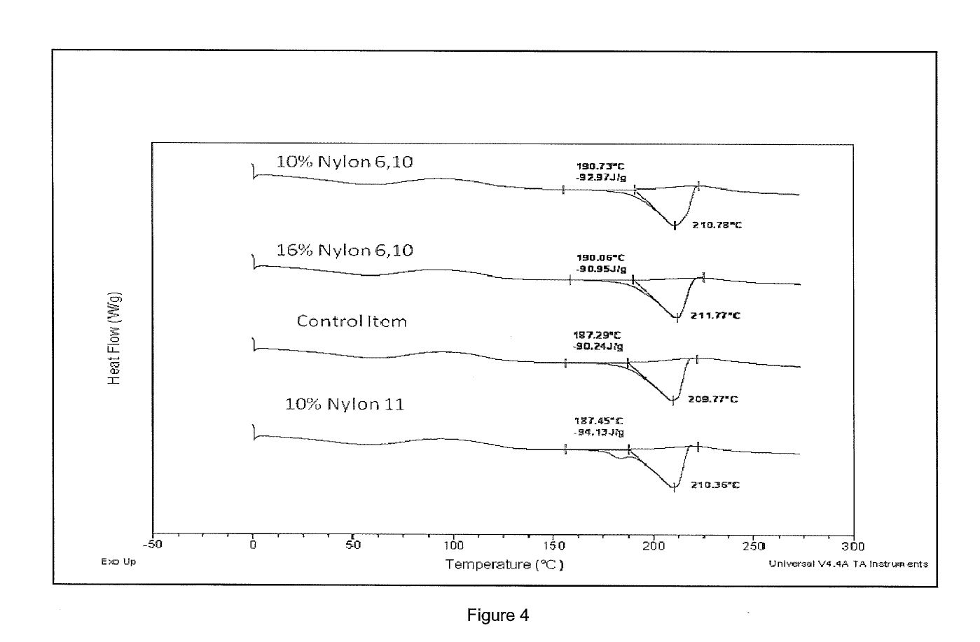

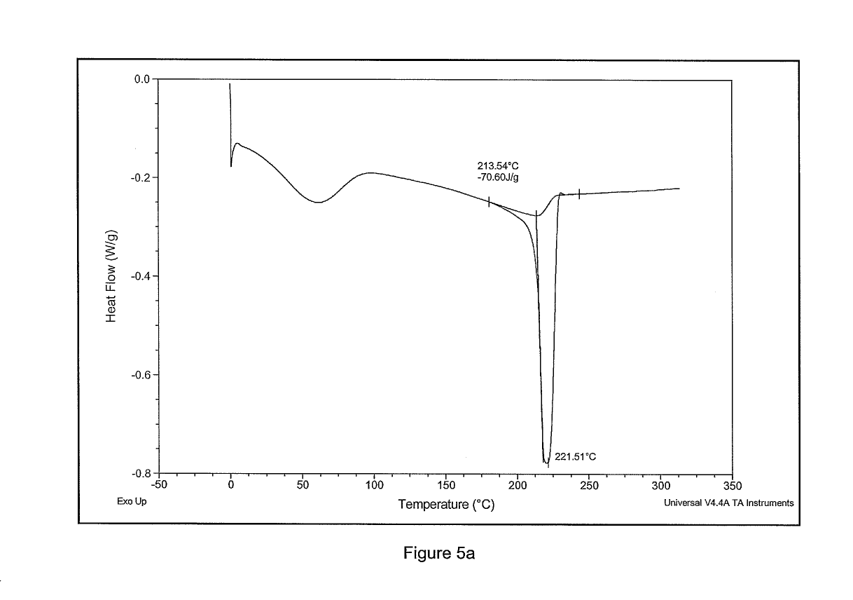

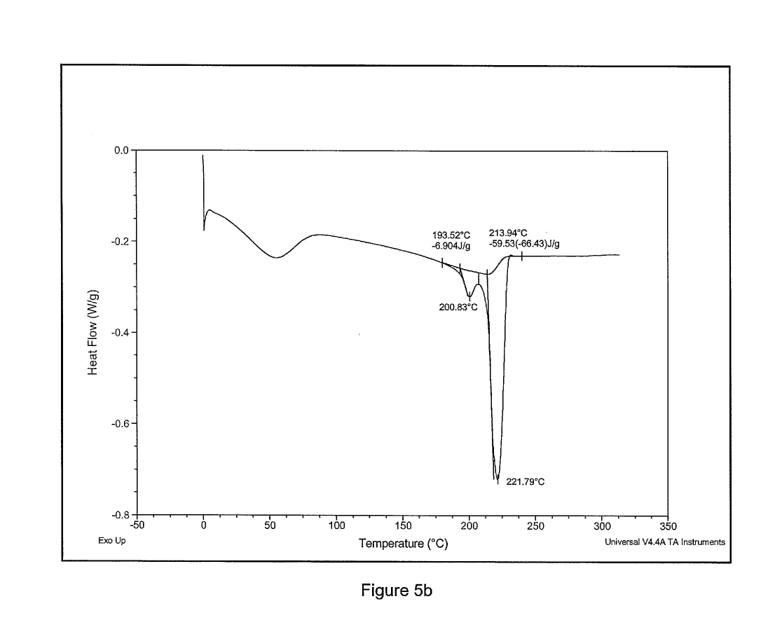

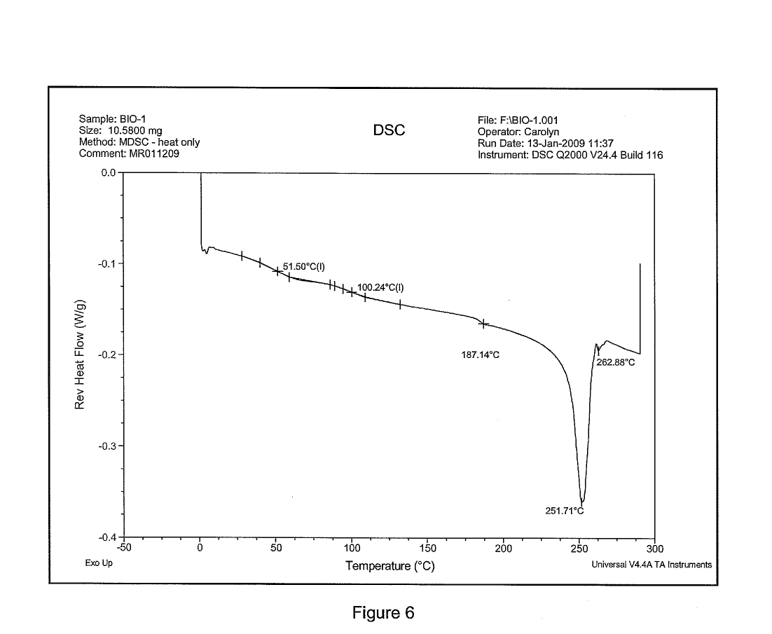

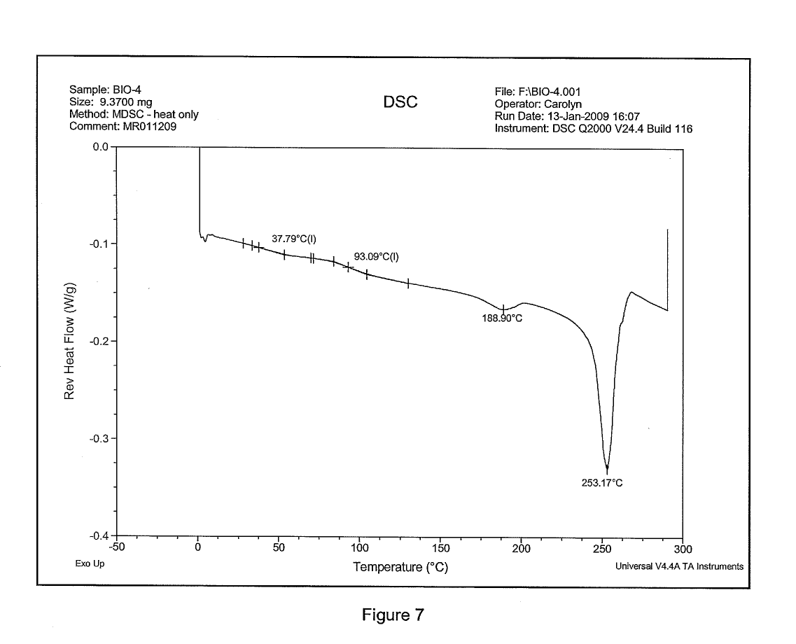

As shown in FIGS. 2-4, the resulting polymer alloy shows no melting point depression over a single component system, which is common in the case of a molecular dispersion or co-polymer of two or more components. Also, FIG. 5 shows that the melt blended polymer alloy can have a crystallization energy of about 90% or more of the crystallization energy of the polyamide component, showing that the two components of the polymer alloy of the present invention are maintained as separate phases. FIGS. 6 and 7 show that a nylon 6,6 plus 10% nylon 11 polymer alloy of the process of the disclosed invention has no melting point depression over a pure nylon 6,6 system.

Definitions:

IV means Inherent Viscosity. This is measured according to the VN determination procedure of ISO 307:2007 (E), and then normalized for wt % concentration.

RV means relative viscosity in formic acid as measured in 90% formic acid according to ASTM D789 ISO 307:2007(E).

VN means Viscosity in sulfuric acid as measured according to ISO 307:2007(E).

DSC means differential calorimetry, a measurement of the amount of heat either consumed or emitted by a sample as it is heated or cooled, is an indication of melting point, crystallinity and purity of polymers.

A “melt blended polymer” is defined as a mixture of 2 or more polymers which are compatible but not necessarily infinitely miscible in each other. The polymers are combined in melt mixing equipment such as extruders.

Nylon 6 means “polycaprolactam” or [Poly(imino-1-oxohexamethylene)]

Nylon 6,6 means polyhexamethyleneadipamide or

[Poly(iminoadipoyliminohexamethylene)]

Nylon 11 means “poly(imino-1-oxoundecamethylene)]

Moderately Iona chain polyamides are defined as polyamides which, if composed of a single monomer, have between 9 and 12 carbons in their polymer repeat unit, and have between 16 and 20 carbon atoms per repeat unit where the polyamide is comprised of two monomers (one diacid and one diamine). Moderately long chain carbon polyamides specifically include nylon 9, nylon 10, nylon 11, nylon 6,10, nylon 6,9, nylon 10,10, nylon 12 and nylon 6,12.

Test Methods:

Resistance to bleach was determined by knitting a sock of yarn, dying it grey with yellow, red and blue dyes, and placing it in a bleach solution for 4 and 24 hours. At each time interval, the sock is removed and its change in color is measured by a spectrophotometer.

### EXAMPLES

### Comparative Example 1 (1270-Control)

A 1270 denier, 66 filament, semi-dull, 4-hole hollowfil, medium acid nylon 6,6 yarn was made according to a process well known in the art, including U.S. Pat. No. 5,223,196 for polymer, hereby incorporated by reference in its entirety. Subsequently, the medium dye nylon 6,6 polymer chips with amine ends concentration of 37 meq/kg, were conditioned at 165° C. for 8 hours to increase the RV from 37-38 to 60, and were fed into a twin screw extruder running at 190 rpm and a temperature profile of 230° C. at the feed and 285° C. at the discharge. The melted polymer was passed through a booster pump, then through a heated transfer line, spinning pump and filter pack and then to a spinneret which formed the polymer into individual filaments. Total time that the mixture spent in the melt phase was approximately 8 minutes. The filaments were air quenched and then passed by a touch roller where a suitable finish was applied. The finished filaments were then converged in a yarn bundle which was subsequently drawn, passed over heated rolls, bulk textured according the bulk texturing process described by Coon in U.S. Pat. No. 3,525,134, relaxed and wound onto tubes. The polymer viscosity of the finished yarn was 60.8 (RV).

### Example 2 (1270-Test)

1270-A1 was spun in the same prototype spinning machine as item 1270-control (Comparative Example 2) under similar conditions except that nylon 11 (BESNO grade polyamide 11, available from Arkema) was co-added to the extruder with the same nylon 6,6 (RV 60) as used in example 2, at a ratio of 1:9 making 10% by weight of nylon 11. The twin screw extruder ran at 190 rpm and a temperature profile of 230° C. at the feed and 285° C. at the discharge. The melted polymer was passed through a heated transfer line, spinning pump, filter pack and then to a spinneret which formed the polymer into individual filaments. Total time that the mixture spent in the melt phase was approximately 8 minutes. The filaments were air quenched and then passed by a touch roller and a suitable finish was applied. The finished filaments were then converged in a yarn bundle which was subsequently drawn, passed over heated rolls, bulk textured, relaxed and wound onto tubes in the same way as for Example 1.

### Sample Test Procedure for Bleach

Each of the example yarns were made into knit socks and heat-set in Superba heat-setting machine at 265° F. The heat-set knit socks were then dyed individually in small beck dye bath using the following procedure:

The bath ratio was 40:1. Knit socks and water were first added to the bath and then dye auxiliaries (sequesterant) Mayo Quest 200 @0.2% (made by Compass Chemical International LLC), (leveler/retarder) Dowfax @1.0% (made by Dow Chemical) were added. These additions were based on % weight on fiber. Then the dyes Yellow 3R @0.0231%, Red 2B @0.01365%, Blue 4R @0.022% (all are percent on weight of fiber) were added. The dye solution containing the knit socks was then adjusted to pH 6.0 with acetic acid. The bath was then heated to boil for 30 minutes. The knit socks were then rinsed, centrifuged and air dried.

In summary, each fiber knit sock was dyed using the same dye recipe and the same dyeing procedure individually. The dyed knit socks were then each individually tested for bleach performance using the following procedure:

A bleach solution was prepared by diluting Ultra Clorox (6% NaOCl in water) regular bleach to make a 5.25% NaOCl solution. The samples were immersed in this bleach solution at 20° C. in sealed plastic bags thus protecting the samples from exposure to air. The bags were maintained at 20° C. in a constant temperature bath for 4 hours.

The samples were then taken out of the bags and rinsed in running water for 10 minutes. The samples were centrifuge extracted to remove water. They were then immersed in aqueous sodium bisulfate (10 g/liter) for 30 minutes to neutralize excess hypochlorite. The samples were then rinsed in running water for 10 minutes to remove salts and subsequently centrifuge extracted to remove excess water. The samples were then dipped in detergent (7.5 ml. of Ultra Tide liquid detergent in 1 liter of water) for 10 minutes, rinsed with running water, centrifuge extracted and air dried.

The above tests were repeated on additional samples to assess 24 hour bleach performance by increasing the immersion time in bleach to 24 hours, while keeping all other procedures the same as above. Color values (L, a, b) of these knit socks before and after bleach testing were measured using a Data Color Systems spectraphotometer. The Delta E CIE and Delta E CMC were recorded. Machine readings for AATCC gray scale (scale from 1 to 5, 5 being no change) were also recorded.

The L, a, b color readings of each of the dyed knit socks were measured prior to bleach exposure and were recorded as follows:

| Sample | L | A | B |
|---|---|---|---|
| Example 1: 1270- | 60.57 | −0.31 | 2.44 |
| Control | | | |
| Example 2: 1270- | 59.88 | −0.26 | 2.18 |
| TEST | | | |

The results for the 4-hour bleach tests are shown in Table 1.

[Note that lower numbers indicate less color change from the color measured prior to bleach treatment.]

TABLE 1
4 Hour Bleach Test

| | | | | | | Spectra- |
|---|---|---|---|---|---|---|
| | | | | | | meter |
| | | | | | | grey |
| | CIE DL | CIE Da | CIE Db | CMC DE | CIE DE | scale |
| Example 1: | 10.35 | −4.56 | 0.03 | 7.64 | 11.31 | 1.5 |
| 1270- | | | | | | |
| CONTROL | | | | | | |
| Example 2: | 5.54 | −1.54 | −0.55 | 3.24 | 5.78 | 2.5 |
| 1270-TEST | | | | | | |

As shown in this table, 1270-TEST with 10% nylon 11 has a gray scale rating of 2.5 versus 1.5 rating for the control. It also shows a DE CIE of 5.78, significantly smaller than that of the control. This demonstrates that 10% of nylon 11 has improved the 4 hour bleach resistance of the dyed fabric significantly. Dye stability in bleach was substantially better than the control, whether the pre-dye condition was lighter or deeper in initial color intensity (see L values) than the control.

The data for 24 hour bleach tests are shown in Table 2:

TABLE 2
24 Hour Bleach Test

| | | | | | | Spectro- |
|---|---|---|---|---|---|---|
| | | | | | | meter |
| | | | | | | grey |
| | CIE DL | CIE Da | CIE Db | CMC DE | CIE DE | scale |
| Example 1: | 22.89 | −3.31 | 1.69 | 10.89 | 23.19 | 1 |
| 1270- | | | | | | |
| CONTROL | | | | | | |
| Example 2: | 10.90 | −2.58 | −1.81 | 6.31 | 11.35 | 1.5 |
| 1270-TEST | | | | | | |

As shown in the above table, 1270-TEST with 10% nylon 11 has a gray scale rating of 1.5 Vs 1.0 rating for the control. It also shows a DE CIE of 11.35, significantly smaller than that of the control. Again, it can be seen that 10% nylon 11 has significantly improved the 24 hour bleach resistance of the dyed fabric, with clear differentiation from the control samples even after 24 hours of bleach exposure.

### Examples 3-5 (Additional Bleach Resistance Tests)

Additional bleach resistance tests were performed on knit socks made with nylon 6; nylon 6 plus nylon 6,10; and nylon 6 plus nylon 11. The same process for making the fiber, socks, dyeing, and bleaching as described above with respect to Examples 1 and 2 where used here.

The L, a, b color readings of each of the dyed knit socks were measured prior to 4 hour and 24 hour bleach exposure and were recorded as follows. The L, a, and b color readings for the nylon 6,10 and nylon 11 socks are the average readings of the blend percentages. The blend percentages can be found in Table 3.

| | L | L (24 | A | A | b | b |
|---|---|---|---|---|---|---|
| Sample | (4 hour) | hour) | (4 hour) | (24 hour) | (4 hour) | (24 hour) |
| Example 3: | 65.08 | 64.90 | −0.25 | −0.27 | 2.46 | 2.27 |
| Control - | | | | | | |
| Nylon 6 | | | | | | |
| Example 4: | 65.55 | 65.30 | −0.22 | −0.22 | 2.17 | 2.07 |
| Nylon 6,10 | (avg.) | (avg.) | (avg.) | (avg.) | (avg.) | (avg.) |
| Example 5: | 64.44 | 65.02 | −0.16 | −0.17 | 2.05 | 2.14 |
| Nylon 11 | (avg.) | (avg.) | (avg.) | (avg.) | (avg.) | (avg.) |

The results for the 4-hour bleach tests and 24-hour bleach tests at various concentrations of nylon 6,10 and nylon 11 are shown in Table 3 and Table 4, respectively.

[Note that lower numbers indicate less color change from the color measured prior to bleach treatment.]

TABLE 3
4 Hour Bleach Resistance Test at various concentrations of Nylon 6,10
and Nylon 11

| Sample | CIE DL | CIE Da | CIE Db | CIE DE |
|---|---|---|---|---|
| Example 3: | 25.39 | 0.44 | 0.79 | 25.41 |
| Control - Nylon 6 | | | | |
| Example 4a: | 24.09 | 0.19 | 2.57 | 24.23 |
| Nylon 6,10 at 5% | | | | |
| Example 4b: | 24.26 | 0.59 | 1.26 | 24.30 |
| Nylon 6,10 | | | | |
| at 10% | | | | |
| Example 4c: | 22.49 | −0.22 | −0.28 | 22.49 |
| Nylon 6,10 | | | | |
| at 16% | | | | |
| Example 5a: | 23.70 | 0.30 | 0.25 | 23.71 |
| Nylon 11 at 5% | | | | |
| Example 5b: | 22.49 | 0.58 | −0.95 | 22.52 |
| Nylon 11 at 10% | | | | |
| Example 5c: | 17.16 | 0.79 | −3.58 | 17.55 |
| Nylon 11 at 25% | | | | |

TABLE 4
24 Hour Bleach Resistance Test at various concentrations of Nylon 6,10
and Nylon 11

| Sample | CIE DL | CIE Da | CIE Db | CIE DE |
|---|---|---|---|---|
| Example 3: | 26.11 | 0.67 | 0.47 | 26.12 |
| Control - Nylon 6 | | | | |
| Example 4a: | 26.21 | 0.55 | 0.16 | 26.22 |
| Nylon 6,10 at 5% | | | | |
| Example 4b: | 25.39 | 0.66 | 0.53 | 25.41 |
| Nylon 6,10 | | | | |
| at 10% | | | | |
| Example 4c: | 24.32 | 0.34 | 1.93 | 24.39 |
| Nylon 6,10 | | | | |
| at 16% | | | | |
| Example 5a: | 26.11 | 0.51 | −1.49 | 26.16 |
| Nylon 11 at 5% | | | | |
| Example 5b: | 22.67 | 0.45 | −2.01 | 23.07 |
| Nylon 11 at 10% | | | | |
| Example 5c: | 19.11 | 0.43 | −3.74 | 19.48 |
| Nylon 11 at 25% | | | | |

### Examples 6-7 (Crush Testing)

Two fibers, Example 6 and Example 7, were used in crush tests. They were both made under the same set of conditions in the prototype spinning machine. Example 6 was pigmented nylon 6, 6 fiber having a light beige color and tri-lobal cross section. Example 7 was the same type of pigmented fiber except that 20% nylon 11 was co-added with the nylon 6,6 polymer prior to melt blending and spinning the fiber to form a polymer alloy. The fibers were separately twisted into yarns having 5.0 Twists per inch, and heat-set in a Superba machine at 265° F., and tufted into cut pile carpets of 36 ounce face weight, at 1/10″ gauge. The tufted carpets were then coated with latex backing.

Six inch diameter samples were cut from the tufted carpets and tested on a crush testing apparatus, with a load of 50 lbs on a foot area of 1 square inch, thereby generating a pressure of 50 psi on the carpet. The carpet pieces were kept under this load for 10 days, depressing the carpet in the 1 square inch target zone. The original pile height above the backing was measured and compared to the pile height of the depressed zone, using a Pile thickness gauge manufactured by Wronz developments, Christ Church, New Zealand. Measurements were then made 1 day and 7 days after the initial 10 day crush test period to document pile height recovery. These data are provided in Table 5.

TABLE 5

| | | Example 7 |
|---|---|---|
| Description | Example 6 (Control) | (with 20% N11) |
| Original pile height | 0.38556″ | 0.38908″ |
| Pile height after 10 days in | 0.1821″ | 0.19842″ |
| crush test | | |
| % original pile height after 10 | 47.23% | 50.99% |
| days in crush test | | |
| Pile height after 1 day | 0.33602″ | 0.34884″ |
| recovery | | |
| % original pile height after 1 | 87.15% | 89.65% |
| day recovery | | |
| Pile height after 7 day | 0.35696″ | 0.35614″ |
| recovery | | |
| % original pile height after 7 | 92.58% | 91.53% |
| day recovery | | |

These results demonstrate carpet made with Example 7 yarn containing 20% nylon 11 had crush test recovery similar to the control carpet made with Example 63 yarn, having no nylon 11, so fiber with 20% nylon 11 blended with nylon 6,6, to form a polymer alloy has acceptable crush test properties. Further, the nylon yarn made with the disclosed polymer alloy has a percent original pile height after 10 days in a crush test of more than 50% of the original pile height and a percent original pile height after 1 day recovery of more than 89% of the original pile height.

### Examples 8 and 9 (Pigmented Nylon Bleach Resistance)

Four hour bleach tests were also performed on socks made from pigmented nylon 6,6 yarn with 0%, 10%, and 20% by weight nylon 11. Example 8a-c are socks made from beige pigmented yarn containing 0%, 10%, and 20%, nylon 11, respectively. Examples 9a-b are socks made from dark gray pigmented yarn containing 0% and 10%, nylon 11, respectively. The fiber used to make the socks had a trilobal cross-section and an average denier of 1235. The process of making the pigmented fiber is described in U.S. Pat. No. 5,830,572, hereby incorporated by reference in its entirety, except that the polymer chips were conditioned at 201° C. for 8 hours to achieve an RV of approximately 60. Further, nylon 6 was used at the pigmented carrier, which was added to the extruder to achieve the concentrations listed in the table below in the final pigmented polymer. The dyed sock properties are listed in the table below.

| Sample | Blue 57 | Black 64 | Red 60 | Black 64 | Yellow 65 | Red 63 | White 71 |
|---|---|---|---|---|---|---|---|
| Ex. 8a | | | | 43 ppm | 1310 ppm | 153 ppm | 1801 ppm |
| 0% n11 | | | | | | | |
| Ex. 8b | | | | 43 ppm | 1310 ppm | 453 ppm | 1801 ppm |
| 10% n11 | | | | | | | |
| Ex. 8c | | | | 43 ppm | 1310 ppm | 153 ppm | 1801 ppm |
| 20% n11 | | | | | | | |
| Ex. 9a | 2532 ppm | 2473 ppm | 535 ppm | | | | |
| 0% n11 | | | | | | | |
| Ex. 9b | 2532 ppm | 2473 ppm | 535 ppm | | | | |
| 10% n11 | | | | | | | |

The results for the 4-hour bleach tests at the various concentrations of nylon 11 are shown in Table 6. The 4 hour bleach test was performed using the same methods as described above in Examples 1 and 2. As shown below, fibers with the nylon 11 component show improved bleach resistance. Example 8b was visibly less bleached than Example 8a, even though not reflected in the CIE Delta E and Gray Scale Rating.

TABLE 6
4 Hour Bleach Resistance Test at various concentrations of Nylon 11

| | | Gray |
|---|---|---|
| Sample | CIE Delta E | Scale Rating |
| Example 8a (0% nylon 11) | 1.45 | 4 |
| Example 8b (10% nylon 11) | 1.59 | 4 |
| Example 8c (20% nylon 11) | 0.36 | 5 |
| Example 9a (0% nylon 11) | 0.69 | 4.5 |
| Example 9b (10% nylon 11) | 0.11 | 5 |

In general, a minimum affect on yarn properties was found while a significantly beneficial effect to bleach resistance was simultaneously observed at concentrations of about 10% or greater for nylon 11 in a nylon 6,6 or nylon 6 major component matrix. This 10% addition level (90:10 polymer blend) of the minor component caused a relatively small depression of total polymer crystallinity, where total energy of crystallinity was about 64.7 J/g versus about 66.1 J/g for the control as measured by DSC. While it is understood by those skilled in the art that crystallinity measurements may be somewhat affected by the heating or cooling rate being scanned, it is observed here that slight differences in crystallinity from that of the major polymer as measured for the compositions of the present invention are a positive indication that the properties of the main polymer are being largely maintained. Further addition of nylon 11 was found to further reduce crystallization energy of the blend with a concomitant affect on yarn physical properties such as bulk recovery, which were very gradually degraded. A measure of bulk recovery, a 7-day crush test, found very similar performance of the 90:10 polymer alloy blend to the control. Wear testing showed gradually increased wear for the 80:20 polymer alloy blend but almost no affect at 90:10 polymer alloy blend

Additionally, the nylon 6 plus nylon 11 polymer alloy showed improved bleach resistance over the nylon 6 plus nylon 6,10 polymer alloy, when compared at the same concentration percentage. This difference is a surprising result, since one would expect the two alloys to have similar bleach resistance do to their similar molecular architecture and chemical functionality. One possibility for this difference is that the nylon 6 plus nylon 11 alloy demonstrates a more pronounced “island in the sea morphology”, i.e. the two distinct phases are more pronounced compared to the nylon 6 plus nylon 6,10 alloy. This is evidenced by the two energy peaks with the nylon 6 plus nylon 11 alloy verses the one energy peak with the nylon 6 plus nylon 6,10 allow (see FIGS. 2-4).

While the invention has been described in conjunction with specific aspects thereof, it is evident that the many alternatives, modifications, and variations will be apparent to those skilled in the art in light of the foregoing description. Accordingly, the invention is intended to embrace all such alternatives, modifications and variations as fall within the spirit and scope of the claims.

1. A nylon yarn comprising a finely dispersed melt blended polymer alloy comprising i) a polyamide component selected from the group consisting of polyhexamethyleneadipamide, polycaprolactam and mixtures thereof, and ii) a nylon 11 component; wherein the polyamide component is the major component by weight of the total melt blended polymer alloy and wherein the polyamide component has a viscosity of about 2.6 IV or more as measured in 96% sulfuric acid.

2. The nylon yarn of claim 1, wherein the nylon 11 component is dispersed in separately detectable regions that are enclosed by, but not dissolved in, the polyamide component.

3. The yarn of claim 1 wherein the nylon 11 component is present at a concentration in the range of about 2 percent by weight to about 35 percent by weight of the total melt blended polymer alloy.

4. The yarn of claim 1 wherein the nylon 11 component is present at a concentration in the range of about 5 percent by weight to about 20 percent by weight of the total melt blended polymer alloy.

5. The yarn of claim 1, wherein dyed knit socks made from said yarn have at least a positive 0.5 unit difference in gray scale rating when exposed to bleach for 4 hours when compared to dyed knit socks made from yarn containing only the polyamide component.

6. The yarn of claim 1 wherein the melt blended polymer alloy has a crystallization energy of about 90% or more of the crystallization energy of the polyamide component.

7. The yarn of claim 1 further comprising a dye.

8. The yarn of claim 7 wherein the dye is an acid dye.

9. The yarn of claim 7 wherein the dye is a disperse dye.

10. The yarn of claim 1 further comprising a pigment.

11. The yarn of claim 10 wherein the pigment is an organic pigment.

12. A process for producing a nylon yarn comprising:
i) melt blending in an extrusion process consisting of either a twin screw or a single screw extruder with a mixing head, a polyamide component selected from the group consisting of polycaprolactam, polyhexamethyleneadipamide and mixtures thereof, with a nylon 11 component to form a finely dispersed melt blended polymer alloy,
ii) extruding the melt blended polymer alloy through a spinneret to form filaments, and
iii) converging the filaments into a yarn and winding the yarn; wherein the polyamide component comprises at least about 65% by weight of the melt blended polymer alloy; wherein the polyamide component has a viscosity of about 2.6 IV or more as measured in 96% sulfuric acid, and further wherein the nylon 11 component remains in separately detectable regions of the yarn, enclosed by, but not dissolved in, the polyamide component

13. The process of claim 12, wherein the melt blended polymer alloy further comprises an organic pigment.

14. The process of claim 12 further comprising drawing and bulk-texturing the yarn.

15. The process of claim 12, further comprising dyeing the yarn.

16. The process of claim 15 wherein the dye is an acid dye.

17. The process of claim 15 wherein the dye is a disperse dye.

18. A process for producing a bleach resistant nylon carpet comprising:
i) melt mixing a polyamide component selected from the group consisting of polycaprolactam, polyhexamethyleneadipamide, and mixtures thereof, with a nylon 11 component to form a finely dispersed melt blended polymer alloy,
ii) extruding the melt blended polymer alloy through a spinneret to form filaments,
iii) converging the filaments into a yarn,
iv) drawing the yarn,
v) bulk texturing,
vi) winding the yarn,
vii) tufting the yarn into a carpet, and
viii) optionally dyeing the carpet; wherein the polyamide component has a viscosity of about 2.6 IV or more as measured in 96% sulfuric acid; and further wherein the nylon 11 component of the yarn is dispersed in separately detectable regions that are enclosed by, but not dissolved in, the polyamide component.

19. The process of claim 18, wherein the melt blended polymer alloy further comprises an organic pigment.

20. The process of claim 18, wherein the carpet is dyed with an acid dye.

21. The process of claim 18 further comprising the step of treating the carpet with a stain resistant chemical.

22. The process of claim 18 further comprising the step of treating the carpet with a soil resistant chemical.

23. A bleach resistant nylon carpet comprising:
i) a polyamide yarn comprising a finely dispersed melt blend polymer alloy comprising a polyamide component selected from polycaprolactam, polyhexamethyleneadipamide, and mixtures thereof, and a nylon 11 component, and
ii) carpet backing, wherein the polyamide component has a viscosity of about 2.6 IV or more as measured in 96% sulfuric acid; and further wherein the nylon 11 component is dispersed in separately detectable regions that are enclosed by, but not dissolved in, the polyamide component.

24. The nylon carpet of claim 23 further comprising a dye.

25. The nylon carpet of claim 24 wherein the dye is an acid dye.

26. The nylon carpet of claim 24 wherein the dye is a disperse dye.

27. The nylon carpet of claim 23 further comprising a pigment.

28. The nylon carpet of claim 27 wherein the pigment is an organic pigment.

29. The nylon carpet of claim 23, wherein the nylon yarn, having an original pile height, recovers more than 50% of the original pile height immediately after a 10-day crush test at 50 psi.

30. The nylon carpet of claim 23, wherein the nylon yarn, having an original pile height, recovers more than 89% of the original pile height within 24 hours following a 10-day crush test at 50 psi.

31. A process for producing a pigmented, bleach resistant nylon carpet comprising:
i) melt mixing a polyamide component selected from the group consisting of polycaprolactam, polyhexamethyleneadipamide, and mixtures thereof, with a nylon 11 component and a minor pigmented polymer component, to form a finely dispersed melt blended polymer alloy,
ii) extruding the melt blended polymer alloy through a spinneret to form filaments,
iii) converging the filaments into a yarn,
iv) drawing the yarn,
v) bulk texturing,
vi) winding the yarn,
vii) tufting the yarn into a carpet, and
viii) optionally dyeing the carpet; wherein the polyamide component has a viscosity of about 2.6 IV or more as measured in 96% sulfuric acid; and further wherein the nylon 11 component of the yarn is dispersed in separately detectable regions that are enclosed by, but not dissolved in, the polyamide component.
